(19) United States
(12) Patent Application Publication
(10) Pub. No.: US 2007/0083590 A1
(43) Pub. Date: Apr. 12, 2007

(54) NETWORK SYSTEM ALLOWING A PLURALITY OF CLIENT COMPUTERS TO SHARE A BURNER DEVICE AND THE METHOD FOR THE SAME

(76) Inventor: Kun-Ta Tsai, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/307,963

(22) Filed: Mar. 1, 2006

(30) Foreign Application Priority Data
Oct. 11, 2005 (TW) 094135374

(51) Int. Cl. G06F 15/16

(52) U.S. Cl. 709/203

(57) ABSTRACT

A network system includes a plurality of client computers coupled to a transmission network, each of the client computers capable of generating commands and data for used in burning; a burner device capable of burning burn data onto discs; and a network server coupled between the transmission network and the burner device for receiving the burn commands and the data transferred from the transmission network and controlling the operation of the burner device.

### BACKGROUND OF THE INVENTION

1. Field of the Invention

The present invention relates to a network system and the method for the same, and more specifically, to a network system and the method for the same allowing a plurality of client computers to share a burner device.

2. Description of the Prior Art

Please refer to FIG. 1, which is an illustration of a conventional network system 10. The network system 10 comprises a network server 12, a burner device 14, a client computer 16, and a transmission network coupled between the network server 12 and the client computer 16.

In the network system 10, the client computer 16 generates data to be burned and exchanges data with the network server 12 via the transmission network 18. For example, the client computer 16 transfers generated data to be burned to the network server 12 through the transmission network 18, and the network server 12 can control the operation of the burner device 14. Practically speaking, the network server 12 controls the burner device 14 to burn data onto a disc.

However, only the network server 12 has access to control the operation of the burner device 14 in the network system 10. In other words, the burner device 14 is directly controlled only by the network server 12 and provides no direct accessibility to the client computer 16 coupled to the transmission network 18. This shall result to wasteful device resources and poor resource sharing. The client computer 16 burns data on a disc only when the burner device 14 is installed directly on the client computer 16. That is, the burner device 14 must be unplugged from the network server 12 and installed on the client computer 16, or the data to be burned must be firstly copied to the network server 12.

### SUMMARY OF THE INVENTION

The claimed invention provides a network system allowing a plurality of client computers to share a burner device. The network system comprises a plurality of client computers coupled to a transmission network, each of the client computers capable of generating burn commands and data; a burner device capable of burning data onto discs; and a network server coupled between the transmission network and the burner device for receiving burn commands and data transferred from the plurality of client computers via the transmission network and controlling the operation of the burner device.

The claimed invention also provides a method for burning data from a plurality of client computers. The method comprises steps of arranging data from the plurality of client computers in order, when a network server receives burn commands and data from the plurality of client computers, and burning data from the plurality of client computers in the order arranged in the previous step.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of a conventional network system.

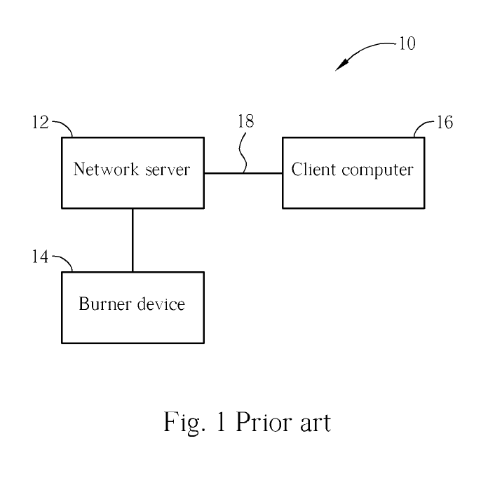

FIG. 2 is an illustration of a first exemplary embodiment of a network system according to the present invention.

FIG. 3 is an illustration of a second exemplary embodiment of a network system according to the present invention.

FIG. 4 is a flow chart for the operation of the network system in FIG. 3

### DETAILED DESCRIPTION

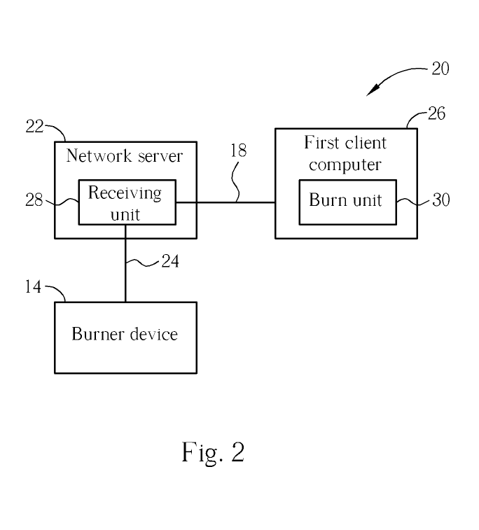

Please refer to FIG. 2, which is an illustration of a first exemplary embodiment of a network system 20. The network system 20 comprises a network server 22, a bus 24, a burner device 14, a transmission network 18, and a first client computer 26. The burner device 14 is coupled with the network server 22 via the bus 24 and the transmission network 18 is coupled between the network server 22 and the first client computer 26. The transmission network 18 can be an Ethernet, and the bus 24 can be a universal serial bus 24 (USB), or an integrated drive electronics (IDE) bus.

In the network system 20, the first client computer 26 generates data to be burned, and corresponding burn commands using an internal burn unit 30. The transmission network 18 transmits the data toe be burned and the burn commands generated by the first client computer 26 to the network server 22. The network server 22 receives the data to be burned and the burn commands transmitted through the transmission network 18 by a receiving unit 28 of the network server 22, and controls the burner device 14 to burn the data to be burned onto a disc according to the burn commands. The receiving unit 28 of the network server 22 is coupled between the transmission network 18 and the burner device 14.

In such way, the first client computer 26 coupled with the transmission network 18 can remotely control the operation of the burner device 14.

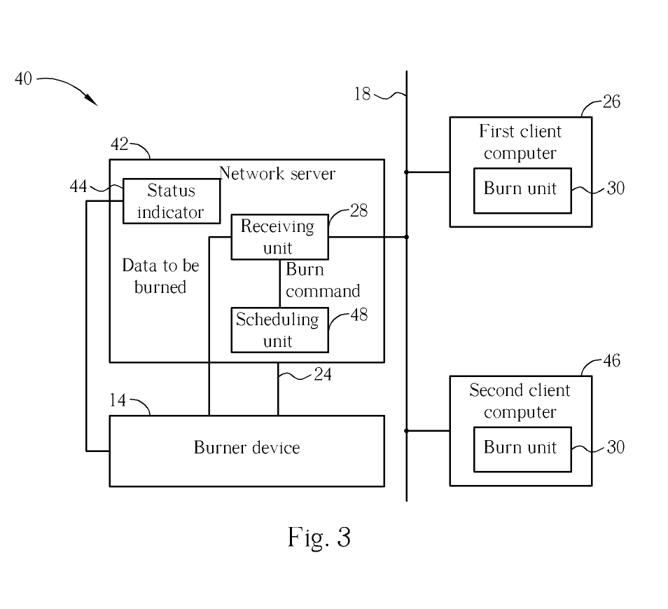

Please refer to FIG. 3, which is an illustration of a second exemplary embodiment of a network system 40. In addition to the burner device 14, the bus 24, the transmission network 18, and the first client computer 26, the network system 40 further comprises a network server 42 and a second client computer 46. The burner device 14 is coupled with the network system 42, and the second client computer 46 is coupled with the transmission network 18, as well.

In the network system 40, the second client computer 46 can also generate data to be burned and corresponding burn commands using the internal burn unit 30. The transmission network 18 transmits the data to be burned and the burn commands generated by the first and second client computers 26, 46 to the network server 42. The network server 42 receives the data to be burned and the burn commands transmitted through the transmission network 18 by the receiving unit 28 of the network server 42. The receiving unit 28 of the network server 42 is coupled between the transmission network 18 and the burner device 14.

When the burner device 14 continuously burns data onto a disc, the network server 42 may receive other data to be burned and burn commands from the transmission network 18 (For example, the network server 42 may receive data to be burned and burn commands generated by the second client computer 46 when the burner device 14 is continuously burning data generated by the first client computer 26 onto a disc.). The network server 42 may also receive data to be burned and burn commands from the first and second client computers 26, 46 via the transmission network 18 at the same time. In order to keep the burner device 14 as busy as possible, i.e., the burner device 14 can process burn work of the second client computer 46 despite burn work of the first client computer 26 being unfinished, the network server 42 of the network system 40 further comprises a scheduling unit 48 for analyzing the burn commands generated by the first and second client computers 26, 46, and for arranging the data to be burned by the burner device 14 in order, the data being generated by the first and second client computers 26, 46. The scheduling unit of the network server 42 is coupled between the receiving unit 28 and the burner device 14. The scheduling unit 48 arranges the data in order according to the receiving-completed time of data from the plurality of client computers 26, 46, data with earlier receiving-completed time having higher priority to be burned.

Additionally, the network server 42 further comprises a status indicator 44 for displaying the status of operation of the burner device 14. For example, when the burner device 14 is burning data onto a disc, the status indicator 44 indicates “busy”. Contrarily, when the burner device 14 doesn't burn any data, the status indicator 44 indicates “available”. The status indicator 44 is coupled with the burner device 14.

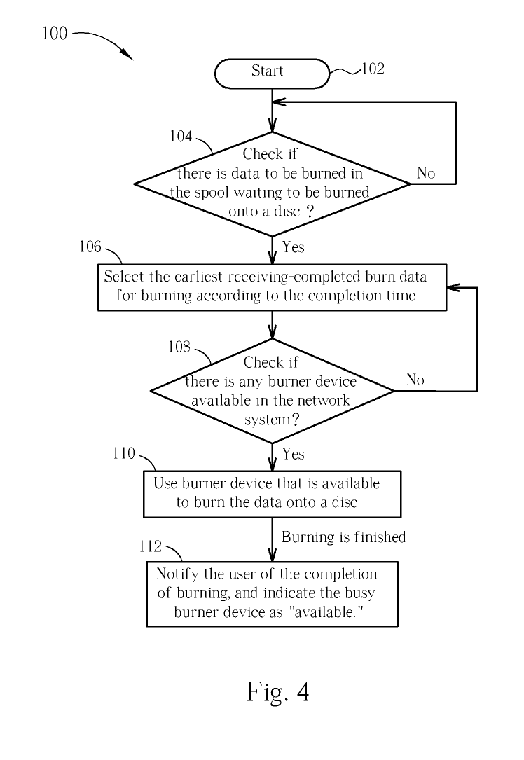

Please refer to FIG. 4, which illustrates a flow chart 100 for the operation of the network system 40. The flow chart 100 comprises the following steps:

Step 102: Start;

(The receiving unit 28 of the network server 42 receives the data to be burned and the burn commands generated by the first and second client computers 26, 46, stores the data and the commands in a spool (not shown), and keeps track of receiving-started time and receiving-completed time of the data to be burned. The burner device 14 burns the data in the spool onto a disc.)

Step 104: Check if there is data to be burned in the spool waiting to be burned onto a disc; if there is, Step 106 is executed; otherwise, Step 104 is executed;

Step 106: Select the earliest receiving-completed data for burning according to the completion time;

Step 108: Check if there is any burner device available in the network system 40; if there is, Step 110 is executed; otherwise, Step 106 is executed;

(check if the status indicator 44 indicates “available”)

Step 110: Use burner device that is available in Step 108 to burn the data selected in Step 106 onto a disc, and indicate the available burner device as “busy”; and

(the status indicator 44 indicates a sign of “busy”)

Step 112: After the burning is completed, notify the user of the completion of burning, and indicate the busy burner device as “available.”

In the exemplary embodiments according to the present invention, the burn units 30 of the first and second client computers 26, 46, and the receiving unit 28 along with the scheduling unit 48 of the network server 22, 42 can be firmware or program code stored in a memory.

Compared with the prior art, the network system (including the network systems 20, 40) of the present invention provides all the client computers (such as the first client computer 26 and the second client computer 46) that are coupled to the transmission network 18 with shared burner device 14 for resource sharing. Secondly, it is not necessary to connect the burner device 14 directly to the first or second client computers 26, 46, the data to be burned generated by the client computers does not have to be copied to the network servers 22, 42 (only the network servers 22, 42 connect to the burner device 14), and data to be burned from the client computers can be burned onto a disc. Finally, a scheduled burn process can be achieved by the network system of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network system allowing a plurality of client computers to share a burner device, comprising:
a plurality of client computers coupled to a transmission network, each of the client computers capable of generating burn commands and data;
a burner device capable of burning data onto discs; and
a network server coupled between the transmission network and the burner device for receiving burn commands and data transferred from the plurality of client computers via the transmission network and controlling the operation of the burner device.

2. The network system of claim 1 wherein the network server comprises:
a receiving unit for receiving the burn commands and data generated by the plurality of client computers; and
a scheduling unit coupled to the receiving unit for arranging data to be burned by the burner device in order, the data generated by the plurality of client computers.

3. The network system of claim 1 wherein the network server comprises a status indicator coupled to the burner device for displaying the status of operation of the burner device.

4. The network system of claim 1 wherein the transmission network is an Ethernet.

5. The network system of claim 1 wherein the network server is coupled to the burner device with a universal serial bus (USB) or an integrated drive electronics (IDE) bus.

6. The network system of claim 1 further comprising a plurality of burner devices coupled to the network server.

7. A method for burning data from a plurality of client computers, comprising steps of:
(a) arranging data from the plurality of client computers in order, when a network server receives burn commands and data from the plurality of client computers; and
(b) burning data from the plurality of client computers in the order arranged in step (a).

8. The method of claim 7 wherein in step (a), when the network server receives the burn commands and data from the plurality of client computers, the network server arranges the data in order according to the receiving-completed time of data from the plurality of client computers, data with earlier receiving-completed time having higher priority to be burned.

9. The method of claim 7 further comprising step of detecting an available burner device for burning.

10. The method of claim 7 further comprising step of setting a status of a burner device to a busy status when the burner device is burning data.

11. The method of claim 7 further comprising step of setting a status of a burner device to an idle status when the burner device is not burning data.

12. The method of claim 7 further comprising steps of:
(c) detecting whether there is data queued for burning when the network server receives the burn commands and data from the plurality of client computers;
wherein step (c) is executed before step (a).
